(19) United States
(12) Patent Application Publication
(10) Pub. No.: US 2014/0055568 A1
(43) Pub. Date: Feb. 27, 2014

(54) ANALYSIS APPARATUS FOR CONTACTLESS ANALYSIS OF THE SHAPE OF A TRANSPARENT BODY, AND METHOD FOR CARRYING OUT THE CONTACTLESS ANALYSIS

(71) Applicants: Carsten Etzold, Bonaduz (CH); Friedrich Neuhaeuser-Wespy, Zuerich (CH)

(72) Inventors: Carsten Etzold, Bonaduz (CH); Friedrich Neuhaeuser-Wespy, Zuerich (CH)

(21) Appl. No.: 14/114,431

(22) PCT Filed: Apr. 27, 2012
(86) PCT No.: PCT/EP2012/057705

§ 371 Date: Oct. 28, 2013

(30) Foreign Application Priority Data
Apr. 29, 2011 (DE) 10 2011 050 024.3

(51) Int. Cl. G01B 11/24; G01B 11/06

(52) U.S. Cl. CPC G01B 11/24; G01B 11/0616
USPC 348/46

(57) ABSTRACT

The invention relates to an analysis apparatus for the contactless analysis of the shape of a transparent body, in particular of a substantially spherical active substance bead, having at least one support for the body and at least one image recording apparatus, wherein the support has a test image, in particular a test grid, and at least one detection means is provided in order to detect, using the detection means, the three-dimensional shape and/or contour of the body and/or the test image which is modulated by the optical properties of the body, in particular the test grid. The invention also relates to a method for the contactless analysis of the shape of the transparent body.

### CROSS REFERENCE TO RELATED APPLICATIONS

This application is entitled to the benefit of and incorporates by reference essential subject matter described in International Patent Application PCT/EP2012/057705, filed Apr. 27, 2012, and German Patent Application 10 2011 050 024.3, filed Apr. 29, 2011.

### FIELD OF THE INVENTION

The invention relates to an analysis apparatus for contactless analysis of the formation of a transparent body, particularly of a substantially spherical active agent bead, with at least one support for the body and at least one image recording apparatus and a method of performing contactless analysis.

### BACKGROUND OF THE INVENTION

Active agent beads, as known for example from U.S. Pat. No. 7,297,331, are formed of a carrier material, spherical structures, in which an active agent or a material generating an active agent is embedded or enclosed.

From U.S. RE38,027 E a method is known, wherein the active agent beads are made from a gel-like support material, preferably a biopolymer such as agarose. In the method, the biologically active material is embedded in the carrier material, for example an active agent or active agent generating material. Due to the properties of the carrier material and the manufacturing method heterogeneous shapes and/or inclusions may occur in the bead, which are undesirable and detrimental to the further use of the beads. To encounter this hitherto a visual inspection of the individual beads is made by the laboratory staff.

In the automated manufacture of the active agent beads it is problematic that due to the manufacturing method a control of the mostly spherical shape of the active agent beads is necessary to ensure consistent quality or uniform shape of the bead, respectively. In the course of high-throughput methods for the production of the beads a steadily increasing number of beads has to be tested what is not feasible with reasonable effort in non-automated procedures.

The high number of beads that can be produced simultaneously in automated procedures results in a need to also perform automated quality control to maintain the desired workflow.

The spherical embodiment of the active agent beads is desired, since only completely uniform active agent beads of approximately the same size and structure can be used for example for the treatment with the active agent beads.

For the evaluation of the quality of the manufactured active agent beads not only their three-dimensional shape but also their internal structure is crucial. This can, because the bodies are formed of transparent material, such as agarose or another transparent biopolymer also be tested in an automated process. If the internal structure differs from a structure considered as ideal and uniform, the respective active agent beads or transparent bodies are discarded as those are unsuitable for use of the active agent bead.

Many of the previously known devices only allow for the control or analysis of the three-dimensional shape or contour of the body. Further and additional information about the internal structures of the body cannot be obtained with these known devices. Crucial for the further use of the manufactured active agent beads, however, is that both the three-dimensional shape or contour as well as the internal structure of the body or the body material or support material will meet certain quality requirements, in particular having a homogeneous distribution or texture to provide optimal active agent beads.

### SUMMARY OF THE INVENTION

It is therefore an object of the present invention to provide an apparatus that allows for quickly and reliably analyzing and checking beside the three-dimensional shape also the internal structure of also a large number of transparent bodies, in particular of substantially spherical active agent beads.

This object is achieved by a device according to claim 1 and in a method according to claim 18, advantageous embodiments of the invention are subject of the dependent claims.

The analysis apparatus according to the invention for contactless analysis, quality control, or inspection of the formation of a transparent body, in particular a substantially spherical active agent bead comprises at least a support for the body and at least one image recording device.

The analysis device according to the invention is characterized in that on the carrier, a test pattern, in particular in the form of a test grid is provided. The apparatus further includes a detection means which detects the three-dimensional shape and/or contour of the body. In addition or alternatively by the detection means, a detection of test pattern modulated due to the optical properties of the transparent body can be gathered. The data recorded by the detection means with respect to the three-dimensional shape and/or contour of the body or with respect to the test pattern modulated by the optical properties of the body can be made available for an evaluation and quality control or analysis of the transparent body after gathering.

In a favorable embodiment the analysis apparatus has a detection means, which is designed as a camera pivotable about at least one axis of the support. This camera allows the detection of the body in image planes differing from each other. Simultaneously or alternatively thereto, with the camera a picture of the test pattern or test grid modulated due to the optical properties of the body to be analyzed may be captured. Again, the capturing of the picture in a plurality of planes or a plurality of recording angles with respect to the body or the support is possible.

From the superposition of different picture planes on the one hand a three-dimensional image of the shape or contour of the body may be generated. On the other hand the pictures taken from different planes or angles of the pattern allow for conclusions concerning the internal structure and distribution in the material of the transparent body to be tested.

The body can thus on the one hand be analyzed in terms of its three-dimensional shape or contour on the other hand with respect to the homogeneity of the carrier or body material used and if necessary be rejected.

In a further preferred embodiment of the analysis apparatus, the latter has at least two cameras. These cameras are each arranged in a defined angle with respect to at least one axis of the carrier or body. The cameras thus allow for recording the transparent body and the optical properties of the test grid or test pattern modulated by the internal structure or by the transparent body.

From the analysis of the recorded images a three-dimensional image of the body can be produced, for example, in an evaluation or analysis unit arranged downstream. Moreover, by the also possible superposition of the images a statement on the inner structure and (uniform) distribution of material in the body or active agent bead can be made. The use of two cameras is particularly suitable for an analysis of a plurality of transparent bodies arranged on the carrier. Here only a single recording per camera must be made. Thus, a high-throughput analysis method can be performed. The fixed arrangement of the cameras has also the advantage that no mechanical parts necessary due to the pivoting movement of the camera must be provided. The analysis apparatus can therefore be achieved maintenance-free and thus cost-effective.

The analysis apparatus provides that the carrier comprises a test pattern, in particular a test grid or the like, which is modulated due to the optical properties of the bodies to be analyzed. It is considered favorable in this context if the test pattern is disposed on or in the carrier. The test pattern itself conveniently has pixels with a defined distribution in an image plane. The form or structure related optical properties of the transparent body to be analyzed, cause a detectable distortion of the distribution of the test pattern. From the degree or the manner of distortion statements, as part of an evaluation of the deviation from a reference distortion, on the uniformity or inhomogeneity of the distribution of material in the body, inclusions of for example, air, contour and/or shape deviations etc., may be made.

In an advantageous embodiment pixels are formed as lines parallel or crossing at an intersection angle. The shape-related properties of the optical body or of the transparent material forming the body result in a detectable distortion of parallel or intersecting lines and cause a flexion or curvature of lines or intersection angles. Again, from the captured images of test pattern, an actual value for the distortion can be determined, allowing for conclusions on the optical properties and influencing factors in the active agent bead. In comparison with a target value it can be defined whether the distortion, which means inhomogeneity of the body material causing the distortion lies within an allowable tolerance range or not. If the tolerance is exceeded, the transparent body is discarded.

The test pattern that is, as already stated, preferably disposed on or in the support, can, for example be positioned in the support by engraving. Alternatively it is possible that the test pattern or test grid is printed or etched on the support. As another possibility for positioning the test pattern on the support using an adhesive film fastened on or stick-on the support, for example by means of static attraction is considered. On this film, the test pattern or test grid is then printed or placed in any other way.

The transparent bodies are positioned on the support manually or automated for the contactless analysis before the recording operation is performed. While the three-dimensional shaping is performed by capturing an image of the transparent body, the test pattern is recorded through the transparent body to be examined. From the picture of the test grid thus not only information on the homogeneity of the body can be derived, the picture of the test pattern at the same time also allows for a review of the transparency properties of the body. If, for example, within the body an active agent generating material is arranged, the transparency of the body is different from the transparency of a body without incorporating an active agent generating material. From the data, which can be derived from the test pattern captured, an information on the presence or the amount of the active agent generating material itself may be gathered. For this purpose, a detected actual value for the transparency is compared with a desired or reference value and from the degree of light permeability the active substance contained in the body or the amount of active agent generating material is concluded.

The detection of the test pattern thus, beside the analysis of the internal structure of the transparent body or active agent beads, also allows for an analysis of the quantity and quality of included active agent or active agent generating material.

In the analysis apparatus the support may be formed as supporting plate or plane, or as rest on which the bodies to be analyzed are spread out or placed. In addition, it is also possible that the support is formed as a pedestal, panel or rack. One of the transparent bodies or spherical active agent beads to be analyzed is then placed on this support, and is then available for analysis or the detection by the detecting means according to the invention analysis apparatus. It is possible that two or more supports are arranged in a horizontal plane of the analysis apparatus to each receive one body at the time. Thus the separation and individual analysis of active agent beads or transparent bodies, respectively is greatly simplified and improved, especially since with the use of stands, pedestals or column-like supports a recording of images of the body is much easier and is not affected by bodies arranged in the surroundings.

A further advantageous embodiment of the invention analysis apparatus provides that the support is provided in the form of a deep-well plate. Such carrier or analysis plate has recesses. Each of these wells is a receptacle for a single body. The scattered arrangement of the bodies to be analyzed in a plate, such as in a 24, 96 or any other format is thus possible. The arrangement of the cameras or other recording means can be optimally adapted to this shape of the support. It can thus be perform faster analysis of several bodies. The analysis process is significantly accelerated.

For the evaluation of the test pattern or of the modulation caused by the transparent body, that is, distortion or deflection of the test pattern, it can be placed on the bottom of the recess. At the same time also the possibility exists that the support is made from a transparent material and is applied or placed on a surface, on which or in which the test pattern or test grid is arranged. In this embodiment of the analyzing apparatus, the optical properties of the support plate are considered in the analysis of the recorded or distorted test pattern.

In order to facilitate and/or to improve the recording of three-dimensional shape of the transparent body to be analyzed, a favorable embodiment of the device provides that the detection means, in particular the camera is configured movable and/or pivotable relative to the support/supports in at least two spatial directions. Alternatively it is possible that the detection means are arranged stationary, and that the support is configured moveably relative to the stationary detection means at least in X- and Y-direction. The mobility of the detection means or the support relative to each other creates the condition that a large number of transparent objects can be captured and analyzed in a single operation. The transparent bodies arranged on the support can thus be recorded and analyzed step by step.

At the same time there is the possibility that, if a plurality of bodies is to be analyzed, only on recording of all bodies is made and the evaluation is performed subsequently in evaluation software respectively configured.

A favorable embodiment of the device provides that the support is configured like a stand, designed for example in the form of a pillar, console or the like. It is provided that in particular two or more supports are arranged perpendicularly aligned with respect to a horizontal plane of the apparatus. Thereby each support receives one transparent body to be analyzed.

In order to facilitate the detection of the three-dimensional shape and/or contour of the body, it is provided in connection with the stand-like design of the support, that this is moveable around a support axis relative to the detection means, in particular a rotational support axis substantially perpendicular to a horizontal plane of the apparatus. It is thus possible to detected a three dimensional image of the body with one or a plurality of fixed detection means. At the same time there is the possibility to capture the test pattern or test grid from a multitude of angles and to provide same for an appropriate evaluation.

In the detection of distortion or deflection of the test image, the optical properties of the transparent body take effect. The distortion or optical deformation is based on a change in the magnification with increasing distance of an image point from the optical axis. Distortion is therefore rotationally symmetrical around a point, which is also called center of distortion. In a uniform round or spherical transparent body a uniform distortion or deflection of the test pattern or test grid viewed through the body takes place. For example, if the grid is formed of parallel lines, it is due to the spherical shape of the transparent body, that starting from the center thereof an increasingly strong curvature of the lines, and a deviation from the parallel arrangement takes place. In an optimal spherical body hereby a uniform distortion or diffraction of lines takes place. If the test pattern is designed in the form of a grid, in which the lines intersect with a defined angle of intersection, this angle of intersection will be different from 90° with increasing distance from the optical center of the spherical body. In a perfectly spherical body a uniform distortion of all angles takes place. If the body differs from optimum or spherical shape, this distortion or deflection will occur unevenly. From the degree of deviation a value for the deviation in the spherical body can then be calculated. If this lies within a tolerable range, the body can be provided for further use. If the deviation from the acceptable range is too large, the body is discarded.

Variations in the internal structure of the body or within the substrate forming the body also lead to a more or less strong distortion or deflection of the test pattern or test grid. Again, from the degree of distortion or deflection, a conclusion can be drawn with respect to homogeneous or non-homogeneous distribution of the carrier material or other disturbances in the carrier material or the active agent or active agent generation material embedded therein. The test pattern has always been described as pattern or grid formed of lines or intersecting lines. Of course, there is also the possibility that any other form and shape of a test pattern is used. The analysis apparatus or software used for analysis of the captured image must then be tuned to the respective test pattern. Since this is an analysis of image points, the final design of the test pattern is essentially irrelevant for its evaluation. In addition to the test pattern or test grid a unique identifier for the body to be analyzed can be recorded and stored together with the data on the shape, or internal structure of each analyzed body by the detection means. This allows an unambiguous assignment of the detected pattern and the detected contour or three-dimensional shape to an analyzed body and allows for better traceability of the manufactured transparent body or active agent beads.

Also, for subsequent use of the active agent bead or transparent body this unique identification is of advantage.

A further advantageous embodiment of the analysis apparatus provides that the test pattern or test grid is used for sizing the body. Here in the test pattern or test grid corresponding mark points, such as scales or the like are provided. At the same time there is the possibility that the test grid comprises circles arranged concentrically that allow for an estimate of the diameter of the spherical transparent body.

There is a possibility that the scale is used for the test or analysis of the shape of the body to be analyzed.

The scale may be formed in the form of crossing or intersecting scales and be used as a measure for the evaluation of the remaining parameters of the transparent body detected by the detecting means.

The analysis apparatus allows for the simultaneous analysis of two or more bodies.

Hereby, it is provided that the detection of the parameters of the single bodies, that is the three-dimensional shape, its size and/or contour and/or an image of the test pattern modulated as a result of the optical properties of the transparent body is detected in parallel or sequentially. The parallel or sequential acquisition applies on the one hand for the detection of the parameters on the other hand for the detection of the individual body. It is hereby provided that the detection means comprise, for example an appropriately divided sensor or chip sensor, so that with capturing a single image all bodies to be analyzed can be recorded. An evaluation is then made, as stated above, by the corresponding image analysis software. In addition, there is of course the possibility that the detection means access each body separately and take a picture, which is then available for analysis.

A further advantageous embodiment of the analysis apparatus provides that the detection means consist of a light source that project a light beam or a ray of light on the body, in particular a laser, and a camera that is arranged in a second angle differing from the first angle, for detecting the dispersion of the light beam or ray of light reflected due to the shape of the body. With this type of detection means a determination of contour and of the three-dimensional shape of the body to be analyzed can be performed in the so-called triangulation method. Corresponding devices are well known for recording three-dimensional body shape. In the inventive device, the camera used for the detection of the reflected light beam or ray of light is additionally used for capturing the test grid or test pattern modulated due to the optical properties of the body to be analyzed. The detection means thus allows in a single step a detection of the three-dimensional shape and contour of the body, and at the same time a detection of the optical properties or the inner composition and/or configuration of the material of the body. The analysis is thus considerably simplified and can be performed more quickly thus resulting in a higher quality testing of the body, in addition to the three-dimensional shape and contour, also the internal structure or error of body structure of can be estimated.

In the context of the present invention as a three-dimensional shape, a substantially spherical or round configuration of the body has to be understood. Of course, there is the possibility that the body takes different geometric shapes, such as oval or other shapes. The particular target or reference form is stored in an evaluation device associated with the analysis apparatus and an automatic comparison with the detected three-dimensional shape of the body is performed. Under the concept of “contour” the outer contour or the outer contour line of the body to be analyzed has to understood. In the analysis of the detected contour of the body, the captured contour is compared with a well-defined geometrical shape, such as in a spherical body a circle. When departing from the defined geometric patterns it may be assumed, that the body is different from, in this example a spherical shape, and has therefore to be discarded. In the preparation of these exemplary active agent beads it may occur that those have one-sided flattenings. Such errors in shape lead to discarding of the deformed active agent bead. A deformation can be detected by evaluating the captured contour. By recording the body in a plurality of planes statements can be made on the contours in planes. Does a body, for example, in plan view appear to be round, it can, for example in the side view a flattening be determined which leads to discarding the body.

The aforementioned embodiment of the detecting means as a light source and camera operatively connected therewith allows beside a recording of the three-dimensional shape of the body to be analyzed also for a detection of the contour of the body, which in turn can be derived from the three-dimensional shape. The analysis and quality control of the body can thus be substantially improved.

In a beneficial embodiment the analysis apparatus further has an evaluation unit. This allows based on the values derived from the images of the body, the output of an actual value for the size, shape and/or three-dimensional shape of the body and of the modulated test pattern or test grid. At the same time, in the evaluation unit an alignment can be performed with a defined target or reference value for the size, contour and/or three-dimensional shape and the modulated test pattern. Then, based on the evaluation results, a rejection of the differently shaped body or a transfer to a subsequent processing or use station for the body takes place.

It is considered advantageous if in the analysis apparatus also an analysis of the layer thickness of the body can be carried out, provided that it comprises two or more layers. In the production of active agent beads, first a flowable, settable blend that comprises a base material and for example a biologically active material, an active agent or an active agent-forming material can be used to generate therefrom a so-called core-bead by placing the mixture in a fluid bath. With the inventive analysis apparatus, in a first analysis step the shape, that is, the size, contour and/or the homogeneous curing of the core beads can be analyzed. If the core bead hereby already exhibits large deviations from a form or composition considered acceptable, the core beads can be discarded. If the test result is positive, the core bead is subjected to a further manufacturing step and covered with a covering material and subjected to a further curing step. The completed active agent bead thus has a total of two layers. Thickness of the latter is crucial for the further use of the active agent beads. The active agent beads having two layers, results in different optical properties of the core bead compared to the covering layer. In the inventive apparatus, it is provided that the two- or multi-layers of the respective active agent beads may be considered by the captured parameter for the optical properties being evaluated, accordingly. At the same time the analysis apparatus allows for a verification of shape, molding, size and/or contour of the core bead and/or the finished active agent bead.

The invention also provides a method for the contactless analysis of the formation of a transparent body, in particular a substantially spherical active agent bead.

The inventive method comprises the following steps: First, by means of a detection means provided in an analysis apparatus, a detecting of the contour and/or three-dimensional shape of the body is made. The detected contour or shape or embodiment is compared with a reference contour or reference shape. In the course of the comparison a value for the deviation between the detected shape and/or contour and the reference contour or reference shape is determined.

The detection means are also suitable to capture an image of a test pattern modulated due to the optical properties of the transparent body to be analyzed. The captured test pattern or test grid is then compared in a further method step with a reference pattern or reference grid and a value for the deviation between the captured test pattern and reference pattern or reference grid is determined. Hereby it is in particular considered that due to the basic shape of the transparent body a distortion, particularly deflection of the test pattern happens. This is taken into account when determining the value of the deviation between the observed test pattern and reference pattern or reference grid.

In the analysis of the transparent body not all of the above steps have to be performed. It may well be considered to be sufficient to merely detect the contour or three-dimensional shape of the body and align them with a reference contour or reference form to provide an analysis or quality control of the transparent body, which is in particular a substantially spherical active agent bead. Alternatively, it is also possible that only a capturing of the test pattern or test grid modulated due to the optical properties of the body is performed. From the alignment then a statement on the quality or uniformity of the body to be analyzed can be made.

The steps of detecting the contour and/or the three-dimensional shape of the body and the alignment, respectively the determination of the value of deviation between the detected shape and/or contour and the reference contour and the reference shape, and the steps of detecting a test pattern modulated through the body and the alignment of the test pattern with the reference pattern and the determination of a value for the deviation need not necessarily be carried out for each analysis of the transparent body. The steps are additionally or alternatively carried out, both variants are included in the inventive method. Thus, it may for example be useful to only detect the three-dimensional shape of the body or to match its contour and to optionally determine deviations. There is also the possibility of a more detailed quality control or analysis, to perform all steps and to perform alongside the capturing of contour and shape and contour and shape analysis to also detect the (homogeneous) distribution of the material of the transparent body, in order to achieve a final assessment of quality.

The method further comprises in a further advantageous embodiment the step of discarding the body, if it is found that the deviation goes beyond or below of a defined tolerance level. Alternatively to discarding the body in the advantageous development of the method, a step of transfer to a secondary processing stage for the body is provided, if it complies or falls below the defined tolerance limit, thus is within the values specified as a reference, i.e. with respect to shape, contour and modulation of the test pattern meets the requirements of an optimal formation of the transparent body.

In an advantageous development of the method regarded as the invention, it is provided, that for capturing the three-dimensional shape and/or contour an image of the body in differing image planes is taken. After superposition of the images the contour and/or the three-dimensional shape of the body may be calculated or derived therefrom. A derivation of vectors for the formation is then calculated or derived from this three-dimensional shape or contour. These in turn are compared with vectors stored for optimal contour or shape to then determine the respective deviation therefrom. If this in total or also in multi-dimensional analysis lies within a tolerance range, the transparent body is not discarded. The exceedance of tolerance values, results in a rejection of the analyzed body.

The detection of the three-dimensional shape and/or contour is performed in the detection means. In the method, it is regarded as advantageous when the body and the detection means are moved relative to each other. It can then several shots of different image planes be generated, which allow a more accurate and in-depth analysis of the body, so that this also meets the highest quality standards with respect to the shape and/or contour to be available for further processing or use.

An advantageous development of the inventive method provides that the acquisition of the three-dimensional shape and/or contour of the body is carried out in a triangulation. Here, a light beam or a ray of light emitted from a light source is projected on the body and the light beam reflected from the body is captured with a detection device, in particular a camera. From the reflected light beam or ray of light the shape of the body or its contour is then concluded. Simultaneously with detection of the three-dimensional shape and/or contour of the body may, by means of the camera used in a triangulation method, a detection of the test pattern modulated due to the optical properties of the transparent body, be carried out, which is then available for the evaluation as described above.

The inventive method is further developed in that a detection of the test pattern modulated by the body is done through a recording of the test pattern through the body or through a support carrying or receiving the body. Hereby, the optical properties of the body are fully utilized, so that the deviation values can be recorded in an optimal way.

In the evaluation of the detected test pattern it is understood that a substantially regularly molded body causes a substantially uniform distortion of the test pattern. A deviation from the regular body shape thus results in a deviation from the uniform distortion of the test pattern by the body and can be used for calculating the deviation by using the detected value compared with the reference value defined for the optimally molded body.

It is considered to be advantageous in this context, if the test pattern has parallel lines and/or lines intersecting under a defined cutting angle. A substantially uniform distortion or a uniform deflection of the parallel lines or a uniform distortion of the angle of intersection of the intersecting lines of the test pattern is then effected by the body to be analyzed and can be used for comparison with a reference pattern or reference grid. If the measured values for the deviation are within a tolerance range, the analyzed body can be provided for further use.

Another embodiment of the method provides that it is used to analyze a body manufactured in a manufacturing method comprises at least two steps. The body preferably has two covering layers and is formed in form of an active agent bead. The analysis of the body is performed after each step of the manufacturing method. Thus, a first quality control can make statements about the shape, contour, and/or size of a so called core bead manufactured in the first step of the manufacturing method, while in a second step of the manufacturing method, the core bead is covered with a covering material. After this covering, the shape, contour and size of the active agent bead is checked in the invention method again. Because of the evaluation results it can thus be determined whether the core bead produced is used for further processing, that means covering with the covering material or not. Besides, because of the quality of analysis of the finished active agent bead with at least two covering layers, based on the analysis results, it can be decided whether the active agent bead is used, for therapy or the like, or must be discarded. According to the invention it is provided or considered favorable if in the first step of the manufacturing process, only the shape and size of the core bead is detected while after the second step of the manufacturing process in addition to shape, contour and size of the active agent bead also the homogeneous distribution of the covering material or the thickness of the covering layer is analyzed. The analysis are carried out immediately after each individual manufacturing step.

In the drawings, the invention is shown schematically in several embodiments.

### BRIEF DESCRIPTION OF THE DRAWINGS

FIG. 1 shows a preferred embodiment of the inventive analysis apparatus having a detecting means,

FIG. 2 the inventive analysis apparatus with two detection means,

FIG. 3 shows a further preferred embodiment of the inventive analysis apparatus,

FIG. 4 shows a further preferred embodiment of the inventive analysis apparatus, each in perspective view.

### DETAILED DESCRIPTION OF THE DRAWINGS

In the figures, identical or corresponding elements are designated with the same reference numerals and are therefore not described again except where practical.

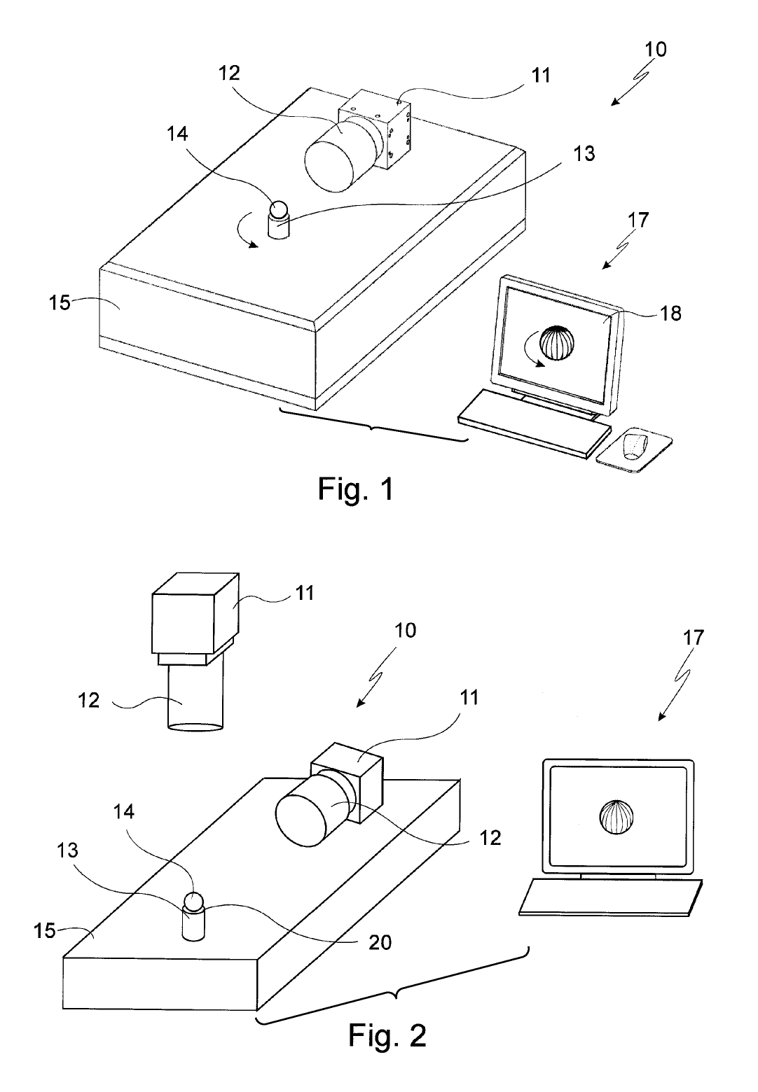

FIG. 1 shows an embodiment of the analysis apparatus 10 according to the invention in perspective view. The analysis apparatus 10 comprises a camera 11, the lens 12 of which is directed onto a support 13. Disposed on the support 13 is a spherical active agent bead 14. With the analysis apparatus 10, a check of the spherical shape or the shape of the active agent bead 14 is to be performed. Therefore the active agent bead 14 is placed on the support 13. The support 13 is itself part of a rest 15, which also carries the camera 11. The support 13 is rotatable in arrow direction. It is thus possible to perform a rotation of the active agent bead 14 relative to the camera 11 or its lens 12. By capturing several images of active agent bead 14 thus after transferring the images to the evaluation unit 17, in the embodiment, a desktop computer, an analysis of the three-dimensional shape of the active agent beads 14 can be performed.

In the evaluation unit 17 the pictures of the active agent bead captured by the camera 11 are superimposed in such a way that a three-dimensional image is generated. This is rotatable in the evaluation unit or its display 18 in the direction of the indicated arrow. The evaluation unit 17 thus allows for verification of the three-dimensional shape of the active agent bead 14. At the same time, with the aid of an appropriate analysis software available in the evaluation unit, a deviation of the shape of the active agent bead 14 from defined reference form can be determined. If the deviation is within a tolerable range, then the active agent bead 14 can be provided for further use, such as for covering with a covering layer or for direct use in medical therapies, or the like and be forwarded to corresponding downstream use stations.

The embodiment of the analysis apparatus 10 illustrated in FIG. 1 is the simplest kind of an analysis apparatus 10. Direct statements about the inner composition of the active agent bead cannot be made since with the camera 11 only a three-dimensional image of the active agent bead 14 can be recorded and provided for evaluation.

FIG. 2 shows another preferred embodiment of the inventive analysis apparatus 10.

This has a total of two cameras 11, which are arranged at an angle to each other. One of the cameras is disposed on the rest 15, while the other camera 11 is mounted hanging above the rest. With the cameras 11 different views of the active agent bead 14 are captured. By overlaying the captured images in an evaluation unit 17 also here a three-dimensional image of the active agent bead 14 can be formed. The analysis apparatus 10, as shown in FIG. 2, thus enables an analysis of the three-dimensional shape and the contour of the active agent bead 14. Due to the arrangement of two cameras 11, a rotatable design of the support 13 can be omitted. With the camera 11 mounted above the support 13 having the active agent bead 14 positioned thereon a capturing of the active agent beads 14 can also be made from above. A test grid 20 applied on the support 13 can thus be taken through the active agent bead 14 with the camera 11 mounted above. With the lens 12 may, mediated via the evaluation unit 17 that at the same time serves for controlling the cameras and taking the pictures, the test grid 20 on the support 13 be photographed through the active agent bead 14. The test grid 20 is modulated due to the optical properties of the active agent bead 14. The picture taken with the camera 11 is also passed to the evaluation unit 17 and is available there for further analysis. The optical properties of the active agent bead 14 will lead to a distortion or deflection of the test grid 20. Is the distortion or deflection within a tolerable range, the active agent bead 14 complies with the requirements of the ideal shape or the ideal composition of the material and its texture or homogeneous distribution within the active agent bead 14. An active agent bead 14, which meets the requirements for three-dimensional shape, contour and inner homogeneity is provided for further use. Active agent beads 14 which not meet these requirements are rejected. The analysis apparatus as illustrated in FIG. 2 allows for performing a corresponding analysis of the active agent bead 14 in a simple and fast manner. The cameras 11 remain hung fixedly to the rest 15 or above. There are thus no moving parts. An adjustment and readjustment of the cameras 11 may be omitted and the reproducibility of the captures is guaranteed.

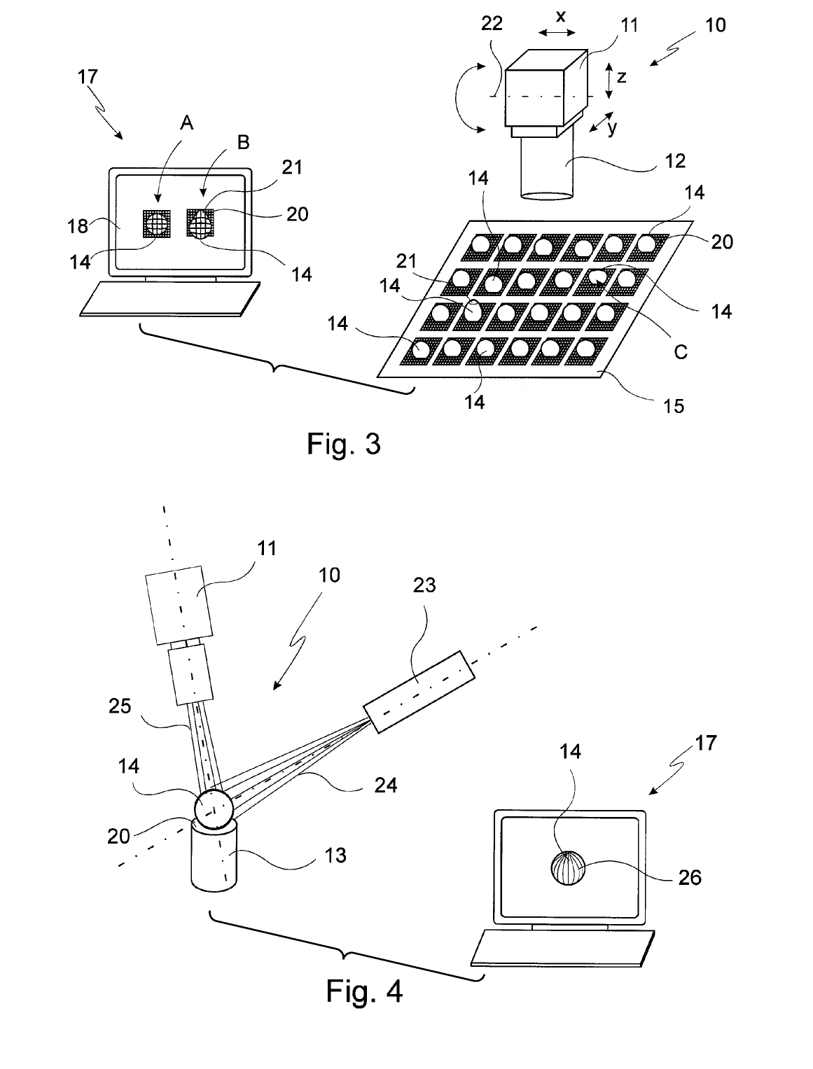

FIG. 3 shows a further preferred embodiment of the inventive analysis apparatus 10.

This also includes a rest 15 and an evaluation unit 17. The evaluation unit 17 is in the form of a conventional desktop computer. In this the various programs for analysis and quality control of active agent beads 14 are operated. The picture of the active agent bead 14 resting on the support 15 is detected with the camera 11 also provided and is transmitted to the evaluation unit 17 and is available for subsequent analysis. In order to perform a direct optical analysis, the evaluation unit 17 has a display 18 on which the pictures of the active beads 14 recorded by the camera 11 can be displayed.

The rest 15 is used in the embodiment of FIG. 3 to accommodate several active agent beads 14 simultaneously. The rest 15 includes a plurality of test grids 20 which are uniformly distributed over the rest 15. In the embodiment of FIG. 3, 24 test grids 20 are uniformly distributed on the rest 15. In this test grid 20, active agent beads 14 to be analyzed are placed. The arrangement of the active agent beads 14 on the rest 15 can for example be made in an automated process with gripper or suction devices. The active agent beads 14 are automatically extracted from a solidifying bath and placed on the rest 15 after several washing steps. In the embodiment of FIG. 3, the rest 15 is to be to understand as a support 13.

The optical properties of the active agent bead 14 modulate, seen through the respective active agent bead 14, the shape and alignment of the test grid 20 or of intersecting or crossing lines forming the test grid. Deviations from the spherical shape lead to other variations in the distribution line or distortion of the lines than this would be the case with an ideal spherical active agent bead. These deviations can be analyzed visually using analysis software or by an operator of the apparatus. By comparison with a reference image, a tolerance value or a deviation from the tolerance value for the optical distortion or deflection of the test pattern 20 by the active agent bead 14 can be captured and displayed. If the distortion or deflection is outside the tolerance range, the corresponding active agent bead 14 is discarded.

If the active agent beads 14, for example, have air inclusions 21, it is due to the change of the optical path through the air inclusion 21 that the test grid, as viewed through the active agent bead 14 has a different bias, than the test grid 20 seen through a homogeneously molded active agent bead 14 having homogeneous distribution of material. An example of such deviating distortion is shown in FIG. 3 as well. Here, a perfectly spherical active agent bead 14 is presented on the display 18 and indicated by arrow A. An active agent bead 14 deviating from the ideal shape beyond the tolerance range is indicated by the arrow B. This active agent bead 14 has an air inclusion 21 at one side. This leads to an irregular distortion or deflection of the test grid 20. The bead, which is indicated by arrow B will be discarded after the completion of the analysis.

A deviation of the contour can also be detected, as it is the case for example in the active agent bead 14 indicated by the arrow C. This active agent bead 14 approaches oval shape. This also leads to a different distortion of the test grid 20. If this distortion is outside a tolerance range, this active agent bead 14 is also to be discarded.

The camera 11 is movable in a total of three spatial directions X, Y and Z. Camera 11 can thus be moved over the rest 15 and the active agent beads 14 positioned thereon and capture images of the individual active agent beads 14. After delivery to the evaluation unit 17 these pictures can be analyzed using analysis software. The associated camera positions can be assigned to individual active agent bead 14 and are stored together with the picture. For automated sorting of the active agent beads 14, this data is then available. Thus for example, active agent beads 14 having a form not complying with the reference can be discarded. These therefore, have a clear digital label that can be used for subsequent automated treatments. The camera 11 can also be pivoted over the axis 22. This embodiment of the pivoting camera 11 allows for, in addition to the images of the test grid 20, to also capture the three-dimensional shape or contour of each active agent bead 14 by taking at least two additional images of each active agent bead 14 from different angles, to then superimpose the pictures in the analysis software.

From the information on distortion or deflection of the test grid 20 and the three-dimensional shape or contour, statements about the quality of the active agent beads 14 can be made. This may be discarded, if the value is outside a tolerance range for deviations in contour, three-dimensional shape and internal structure or the homogeneity of the material distribution.

FIG. 4 shows a further possible embodiment of the analysis apparatus 10. An apparatus for performing a triangulation method to detect the three-dimensional shape of an active agent bead 14 is shown schematically. The analysis apparatus 10, as illustrated in FIG. 4, includes a laser 23 by means of which a light beam 24 is projected onto the active agent bead 14. The active agent bead 14 is disposed on a support 13 and thus accessible from all sides. The analysis apparatus 10 of FIG. 4, is basically a camera 11. This is arranged in a first angle, that differs from a second angle which the laser 23 takes with respect to the active agent bead 14. The camera 11 is used to detect the portion 25 of light beam 24 reflected from of the active agent bead 14. Hence statements about the three-dimensional shape and contour of the active agent bead 14 can then be derived. The pictures captured by the camera 11 are transmitted to the evaluation unit 17 and evaluated there by means of image processing software. In the evaluation unit 17, a three-dimensional image 26 of the active agent bead 14 can then be generated. This three-dimensional image 26 allows for statements about the shape and contour of the active agent bead and whether this is available for further use, for example, a further manufacturing step or the direct use in therapy or must be discarded, since the deviation prescribed by the prescribed form is too big.

In addition to detecting the three-dimensional shape and contour of the active agent bead 14, a test grid 20 which is arranged on the support 13 can be captured with the camera 11. This is then available for the evaluation of the homogeneous distribution of the material in the active agent bead 14, since the image of the test grid 20 is modulated by the optical properties of active agent bead 14 or the material forming the active agent bead 14. Contaminations of the material or variations in a homogeneous distribution of the material will lead to an abnormal distortion or deflection of the test grid 20. This deviation can be quantified by comparison with a reference grid or a reference shape. If the deviation is within the tolerance range, the active agent bead 14 can be made available for further uses. If the deviation is too large, the active agent bead 14 or its precursor, which can also be evaluated by the analysis apparatus 10 as shown in the figures, can be discarded.

In FIG. 4 the analysis apparatus 10 for a single analysis of an active agent bead 14, which is arranged on a support 13 is shown. Alternatively, it is of course also possible that a plurality of active agent beads 14 are arranged on a rest-like support 13 and that the analysis apparatus 10 is moved over this support 13 to capture single images of the active agent beads 14.

At the same time, all analysis apparatus 10 shown in the figures and encompassed by the invention are suitable for the high-throughput analysis of active agent beads 14. For this purpose, the active agent beads 14 or the support 13 carrying the active agent beads 14 or the rest 15 is moved relative to the analysis apparatus 10. Alternatively, of course, the analysis apparatus 10 can be moved relative to the active agent beads 14 arranged on the support 13 or the rest 15, to capture individual images. At the same time it is also possible that with a camera 11 an image of all active agent beads 14 is captured simultaneously and that the image generated thereby is then evaluated and analyzed in an evaluation software, accordingly. Hereby a digital labelling of the individual positions of the active agent beads 14 on the support 13 or the rest 15 can be made, such that it can be clearly gathered which of the active agent beads 14 do not meet the requirements of ideal shape and are to be discard or which active agent beads 14 or precursors thereof are available for further processing and are to be transferred to a subsequent processing stage, accordingly.

### LIST OF REFERENCE NUMERALS

10: analysis apparatus
11: camera
12: lens
13: support
14: active agent bead
15: rest
17: evaluation unit
18: display
20: test grid
21: air inclusion
22: axis
23: laser
24: light beam
25: reflected portion
26: three-dimensional image

1. Analysis apparatus (10) for the contactless analysis of the shape of a transparent body, in particular of a substantially spherical active agent bead (14), having at least one support (13) for the body, characterized in that
the support (13) has a test pattern (20); and
at least one image recording apparatus is provided and includes detection means configured to record at least in one of the three-dimensional shape or contour of the body or the test pattern (20) modulated by the optical properties of the body.

2. Analysis apparatus (10) according to claim 1, characterized in that the detection means has a camera (11) that is provided pivotable around at least one support axis for detecting the body and/or the test image formed in image planes different from each other.

3. Analysis apparatus (10) according to claim 1, characterized in that the detection means has at least two cameras (11), wherein the cameras (11) are arranged in a defined angle to an axis of the support (13).

4. Analysis apparatus (10) according to claim 1, characterized in that the test pattern is arranged at or in the support (13).

5. Analysis apparatus (10) according to claim 4, characterized in that the test pattern can be recorded through the transparent body or the support (13).

6. Analysis apparatus (10) according to claim 1, characterized in that in a horizontal plane of the device two or more supports (13) arranged for each receiving a body.

7. Analysis apparatus (10) according to claim 1, characterized in that the support (13) comprises recesses for each accommodating a body, wherein the test pattern is arranged at or in the bottom of the recess.

8. Analysis apparatus (10) according to claim 1, characterized in that the detection means includes at least one camera that is movable and/or pivotable relative to the one or more supports (13) in at least two spatial directions.

9. Analysis apparatus (10) according to claim 1, characterized in that the support (13) is formed like a stand, wherein two or more supports (13) are arranged aligned perpendicularly to a horizontal plane.

10. Analysis apparatus (10) according to claim 1, characterized in that the detection means includes at least one camera, and the support (13) is movable rotatably relative to the at least one camera around a support axis, aligned perpendicularly with respect to a horizontal plane of the apparatus.

11. Analysis apparatus (10) according to claim 1, characterized in that the test pattern comprises pixels of a defined distribution in an image plane, wherein said shape-related properties of the optical body effect a detectable distortion of the defined distribution.

12. Analysis apparatus (10) according to claim 11, characterized in that the pixels are formed as parallel lines or lines intersecting under a intersecting angle, wherein the shape-related optical properties of the body effect a detectable deflection of the lines respectively of the intersecting angle.

13. Analysis apparatus (10) according to claim 1, characterized in that the detection means includes at least one camera that is configured to obtain a test image of the test pattern and includes an evaluation unit that is configured to perform a sizing of the body based on the test image.

14. Analysis apparatus (10) according to claim 1, characterized in that parallel or sequential detection of the three-dimensional shape, size and/or contour and/or of the modulated test image of two or more bodies, arranged in an array, is provided.

15. Analysis apparatus (10) according to claim 1, characterized in that the apparatus further comprises an image recording apparatus that has a light source, in particular a laser (23), arranged in a first angle with respect to a plane of the body and projecting a ray of light or ray of light (24) on the body, and a camera (11) arranged in a second angle, divergent from the first angle, for detecting the scattering of the reflected ray of light or the grid, wherein the image recording apparatus is movable relative to the body.

16. Analysis apparatus (10) according to claim 15, characterized in that the detection means include an evaluation unit (17) configured to receive an image from the camera (11) and to output an actual value of the size, contour and/or three-dimensional shape of the body and/or of the modulated test pattern and a comparison with a reference value for the size, contour and/or three-dimensional shape and/or the modulated test pattern.

17. Analysis apparatus (10) according to claim 16, characterized in that the body comprises two or more layers, and the evaluation unit is configured to provide an analysis of the layer thickness.

18. A method of direct contactless analysis of the formation of a transparent body, comprising the steps of
a.) capturing an image of the transparent body
b) Detecting at least one of the contour and the three-dimensional shape of the body,
c) comparing the detected contour and/or shape respectively with a reference contour and/or a reference shape, and
d) Determining a value for the deviation between the detected shape and/or contour and the reference contour and/or the reference shape; and
e) based on the value of the deviation, making a decision on either
f) rejecting the body in case the value of the deviation exceeds or underruns a defined tolerance limit, or
transferring the body to a downstream processing stage for the body in case the value of the deviation complies with the defined tolerance limit.

19. A method of indirect contactless analysis of the formation of a transparent body, comprising the steps of
a.) Capturing an image of a test pattern modulated by the transparent body,
b.) comparing the captured image of the test pattern with a reference image of the test pattern,
c.) Determining a value for the deviation between the captured image and the reference image, and
d) based on the value of the deviation, making a decision on either
e) rejecting the body in case the value of the deviation exceeds or underruns a defined tolerance limit, or
f) transferring the body to a downstream processing stage for the body in case the value of the deviation complies with the defined tolerance limit.

20. Method according to claim 18, characterized in that for detecting the three-dimensional shape and/or contour a picture of the body in image planes differing from each other is done and after superposition of the pictures, the contour and/or three-dimensional shape of the body is calculated or derived.

21. Method according to claim 18, characterized in that the body and the detection means are moved relative to each other.

22. Method according to claim 18, characterized in that the three-dimensional shape and/or contour of the body is detected in a triangulation method.

23. Method according to claim 18, characterized in that for detection the test pattern modulated by the body a picture of the test pattern is taken through said body or through a support (13) that carries or receives the body.

24. Method according to claim 18, characterized in that a substantially regular molded body causes a substantially uniform distortion of the test image and a deviation from the regular body shape effects a deviation from the uniform distortion of the test image.

25. Method according to claim 18, characterized in that the test image has parallel lines and/or lines crossing under an intersecting angle and a substantially uniform distortion, a uniform bending of the parallel lines or a uniform distortion of intersecting angles of the intersecting lines of the test pattern is effected.

26. Method according to claim 18, characterized in that the body is formed in a manufacturing method comprising at least two steps, and is formed preferably as active agent bead having two covering layers and a contactless analysis of the drug-beads is provided after each step of the manufacturing process.

27. Method according to claim 26, characterized in that in the first step of the manufacturing process, a core bead is made and after manufacturing, the shape, contour, and size of the core beads is analyzed and in a second step of the manufacturing process, the core bead is covered with a covering material and after the covering the shape, contour and size of the bead is controlled.

28. Method of claim 26, characterized in that after the first step of the manufacturing process, the shape and size of the core bead, and after the second step of the manufacturing process the shape, contour size of the active bead and the thickness of the covering material is analyzed.

29. The method as claimed in claim 19, further comprising:
G) Detecting at least one of the contour and the three-dimensional shape of the body,
h.) comparing the detected contour and/or shape respectively with a reference contour and/or a reference shape,
i.) Determining a value for the deviation between the detected shape and/or contour and the reference contour and/or the reference shape, and
j) comparing the value of the deviation between the determined test image and the reference test image, with the value of the deviation between the detected shape and/or contour and the reference contour and/or the reference shape.
